(19) United States
(12) Patent Application Publication
(10) Pub. No.: US 2010/0185753 A1
(43) Pub. Date: Jul. 22, 2010

(54) UNIFIED PEER-TO-PEER AND CACHE SYSTEM FOR CONTENT SERVICES IN WIRELESS MESH NETWORKS

(76) Inventors: Hang Liu, Yardley, PA (US); Yang Guo, Plainsboro, NJ (US); Yingnan Zhu, Columbia, MO (US)

Correspondence Address: Robert D. Shedd, Patent Operations;THOMSON Licensing LLC, P.O. Box 5312, Princeton, NJ, 08543-5312, US

(21) Appl. No.: 12/733,336

(22) PCT Filed: Aug. 30, 2007
(86) PCT No.: PCT/US07/19094

§ 371 Date: Feb. 24, 2010

(51) Int. Cl. G06F 15/16

(52) U.S. Cl. 709/219

(57) ABSTRACT

A method and apparatus for receiving content over a wireless network are described, including determining a first server from which to receive a content clip to be streamed, requesting the content clip to be streamed from the selected first server, receiving the streamed content clip from the selected first server, determining a peer device from which to receive a content clip to be downloaded, requesting the content clip to be downloaded and receiving the downloaded content clip. The first server is a mesh content server.

### FIELD OF THE INVENTION

The present invention relates to wireless mesh networks and, in particular, to the use of infrastructure multi-hop wireless mesh networks for delivery of high quality content services to client devices.

### BACKGROUND OF THE INVENTION

Conventionally, content is streamed over the Internet to end users either directly from a content source server or indirectly via edge servers in Content Distribution Networks (CDNs). By deploying many edge servers strategically located at the edge of the Internet; the CDN approach is able to reduce the traffic through the network, shorten the users' startup delay, and improve the users' viewing quality. P2P content streaming has emerged as an alternative due to low server infrastructure cost. By utilizing participating users'/peers' resources (upload bandwidth, storage space, processing power, etc.), the available resources in a peer-to-peer system grow in proportion to the number of users/peers. As used herein, “/” denotes alternative names for the same or similar acts or components.

P2P applications were first introduced as a means for file sharing. Applications such as BitTorrent and KaZaa attracted a large number of users and contribute to a large amount of the network traffic over the Internet. Other techniques have also been developed for P2P file sharing. Recently, P2P techniques have also been adopted to support content streaming service. However, P2P streaming experiences problems such as a long start-up delay time and churn-induced instability that can greatly degrade the user experience. Furthermore, most of the P2P streaming work was done in a wired network setting and did not consider the impact of the unique features of wireless networks. Because of limited bandwidth, signal interferences due to shared medium, the multi-hop path problem, the number of flows and the goodput obtained by each flow is limited in a backhaul wireless mesh network (WMN). Goodput is the number of bits per second correctly received by a receiver/client device/end device/end user. The number of peers sharing the same content within a wireless mesh network may be small due to limited network geographic size and peer population. If each peer in the wireless mesh network shares different content with other peers in the wired Internet, heavy traffic load for the gateway results. In addition, if the communication path includes many hops between the gateway and the clients, or among the peers in the mesh network, the communication path will consume a lot of wireless network bandwidth resources, especially in a wireless medium, which is a shared medium. When a transmission occurs between two nodes on a wireless channel, all the other nodes within the interference range cannot transmit any data on the same channel because of interference. With conventional P2P streaming techniques, it is difficult to guarantee the quality of service (QoS) for a reasonable number of content flows in current infrastructure WMNs.

Significant progress has been made in deploying IEEE 802.11 based WMNs to provide last-mile accessibility for Internet users. Meanwhile, streaming of multimedia content over IP networks is becoming increasingly popular. With the growing deployment of WMNs and increasing number of WMNs users, supporting multimedia streaming over wireless mesh network has become increasingly important.

Content streaming over mobile ad hoc networks and wireless mesh networks has been studied. Various client-server techniques, such as multiple description coding and path diversity from a single server to the receiver, have been developed for delivery of content services and transmitting content over wireless networks. Considering wireless network properties and the strict requirements of the streaming applications, cross-layer approaches have also been explored to improve the transport efficiency from a single server to a client device. However such client-server methods do not scale very well and can lead to traffic congestion around the server (or the gateway if the server is in the wired interne).

In wireless mesh networks, the path established between two nodes may go through several relay nodes/mesh access points. Due to self-interference in wireless medium, the path capacity decreases as the hop count increases. Furthermore, large hop counts increase the chance of wireless signal interferences, which negatively impacts both its own flow transmission (self-interference) and other established connections (cross-interference) and reduces the overall system capacity. However, the hop count is not the sole factor determining the path quality. The quality of a radio link depends on the received radio signal strength, the packet loss rate, contention among nearby nodes, link data rate, and traffic load on the link. IEEE 802.11 radios support multi-rate adaptation according to link quality. A multi-hop high rate path may be capable of achieving better throughput and shorter delay than a single hop low rate path. How to provide scalable, high quality media/content streaming service over the wireless mesh network is a challenging problem.

### SUMMARY OF THE INVENTION

Multi-hop wireless mesh networks (WMNs) are emerging as a promising technology that has applicability in metro-area Internet access, public safety, and transient networks. There are two types of mesh networks: client-mesh networks and infrastructure-mesh networks. Client-mesh networks or ad hoc networks are formed by client devices with no infrastructure required. In client-mesh networks, each node plays the same role and participates in packet routing and forwarding. In contrast, infrastructure WMNs consist of mesh access points (MAPs)/routers and client devices. The MAPs are interconnected via wireless links to form a multi-hop wireless mesh backhaul infrastructure. One or more MAPs are connected to the wired Internet and are referred to as gateways. Generally, a MAP has two or more radio interfaces. One radio interface is an access interface, which is for network access of clients. A second radio interface is a relay interface, which is for routing and data forwarding. Client devices (e.g., laptops, dual-mode smart phones, personal digital assistants (PDAs) etc.) associate themselves with a nearby MAP to access the wireless mesh network. Client devices/end devices do not participate in packet relay or the routing process. A client device sends (or receives) packets to (or froth) its associated MAP. Packet delivery in the WMN is handled by the MAP through a backhaul routing protocol.

The present invention is a unified peer-to-peer (P2P) and cache (UPAC) framework for delivery of high quality content services, e.g. content streaming and video-on-demand services over infrastructure multi-hop wireless mesh networks (infrastructure WMNs). As used herein, content includes audio, video, data, information, multimedia etc. Streaming content in multi-hop wireless networks faces many challenges, e.g., the varying available path bandwidth, signal interferences due to shared medium, the impact of multiple relay nodes, etc. To increase the capacity of the infrastructure WMNs and ensure high content quality and streaming services, the present invention caches the content at selected wireless mesh access points (MAPs) in the multi-hop wireless mesh network. Furthermore, peers are used to help in a best effort manner to reduce the workload imposed on the servers and networks. This UPAC framework has the advantages of both content distribution network approach and peer-to-peer networking approach. The UPAC of the present invention fits the specific characteristics of quality-of-service (QoS) aware content services in wireless mesh networks, for optimizing system performance. In UPAC, to obtain optimal content quality, a device can form a peer-to-peer relationship with MAP content cache servers and other peer devices. Meanwhile, a device can also form a client-server relationship with MAP content cache servers. In addition, the methods are described to choose the serving cache server for a client device and the end-to-end route between the server and the client device.

A method and apparatus for receiving content over a wireless network are described, including determining a first server from which to receive a content clip to be streamed, requesting the content clip to be streamed from the selected first server, receiving the streamed content clip from the selected first server, determining a peer device from which to receive a content clip to be downloaded, requesting the content clip to be downloaded and receiving the downloaded content clip. The first server is a mesh content server.

### BRIEF DESCRIPTION OF THE DRAWINGS

The present invention is best understood from the following detailed description when read in conjunction with the accompanying drawings. The drawings include the following figures briefly described below:

FIG. 1 is a schematic diagram of a content service delivery system in accordance with the principles of the present invention.

FIG. 2 is a flowchart of the unified peer-to-peer (P2P) and cache server (UPAC) content service process from the client device side.

FIG. 3 is a flowchart of the centralized mesh content server selection method of the present invention.

FIG. 4 is a flowchart of the overlay mesh content server selection method of the present invention using end-to-end delay as the selection criteria.

FIG. 5 is a flowchart of the distributed mesh content server selection method of the present invention using hop count as the selection criteria.

FIG. 6 is a flowchart of the distributed mesh content server selection method of the present invention using a routing metric as the selection criteria.

FIG. 7 is a block diagram of a mesh content server in accordance with the principles of the present invention.

FIG. 8 is a block diagram of a client device in accordance with the principles of the present invention.

### DETAILED DESCRIPTION OF THE PREFERRED EMBODIMENTS

Given the MAPs as infrastructure in WMNs, as well as the advances in processing power and storage, the present invention caches the content (audio, video and/or multimedia content) at selected wireless mesh access points or co-locates a cache server with selected MAPs in the wireless mesh network in order to increase the system capacity for the video/multimedia services and ensure high content service quality. Furthermore, the present invention uses peers on a best effort basis to balance the workload over the network and reduce the resource consumption along the path between the source and the sink/client device/end device, if possible.

The main differences between the architecture of the present invention and the existing Internet CDN schemes are:
1. A client device in the present invention can concurrently form a P2P relationship with MAP content cache servers and other peer devices as well as a client-server relationship with MAP cache servers.
2. The MAP content cache server in the architecture of the present invention supports both content (audio, video and/or multimedia) streaming and P2P data downloading/fetching. It is important to note that the scheduling scheme for content streaming and P2P content fetching is different. Content streaming requires in-order delivery of streamed content/data. P2P content fetching may use a different dissemination policy among the peers. A dissemination policy is a policy that dictates the selection of the order of the packet dissemination. For example, the next packet disseminated may be the rarest unit of content in the network or the most requested unit of content in the network or some other basis for packet dissemination.
3. The network environment is different. In the Internet, the bottleneck is either at the server or at the client. In wireless mesh networks, the bottleneck may be within the network. The scheme for selecting a cache server to optimize the quality-of-service (QoS) of a content session for a client device is different in the Internet and in a WMN. The present invention includes several alternative server selection schemes.
4. Wireless is shared medium and as such, one content flow may interfere with another flow even if the two flows originate from different content cache servers and do not pass through the same intermediate relay node(s). The server selection schemes of the present invention take this effect into account.
5. Path quality varies over time in a WMN. This is taken into account in the present invention when a client device selects and updates the server and the path.

The present invention is a unified peer-to-peer (P2P) and cache (UPAC) framework/architecture for high quality content (audio, video, multimedia) delivery services, such as video-on-demand and content streaming over infrastructure WMNs. UPAC employs multiple mesh content servers and peer-to-peer techniques. The term “mesh content server” is not intended to be limiting and can distribute any form of content including audio, video, data and multimedia content. To increase the system capacity of the content services and ensure high content quality, the content is cached at selected wireless mesh access points in the mesh network. Alternatively, content servers are co-located with selected MAPs within the wireless mesh network. As used herein, a mesh content server is a MAP with cache or a MAP with a co-located content server. A mesh content server can also be a gateway to the Internet. The mesh content servers in the UPAC perform two roles, content server and peer. As a content server, a mesh content server can stream content to the client devices as requested. As a peer, a mesh content server is a peer for P2P data fetching. The mesh content server supports two scheduling schemes, streaming and data fetching. Streaming requires in-order delivery of streamed content/data. P2P data fetching may use a different dissemination policy, for example, a dissemination policy to maximize data availability among the peers. Client devices, if available in the mesh, serve as best effort peers to further reduce the traffic load imposed on the servers and networks. For optimizing content service quality, a client device can form a P2P relationship with mesh content servers and other peer devices. Meanwhile, a client device can establish a client-server relationship with a mesh content server.

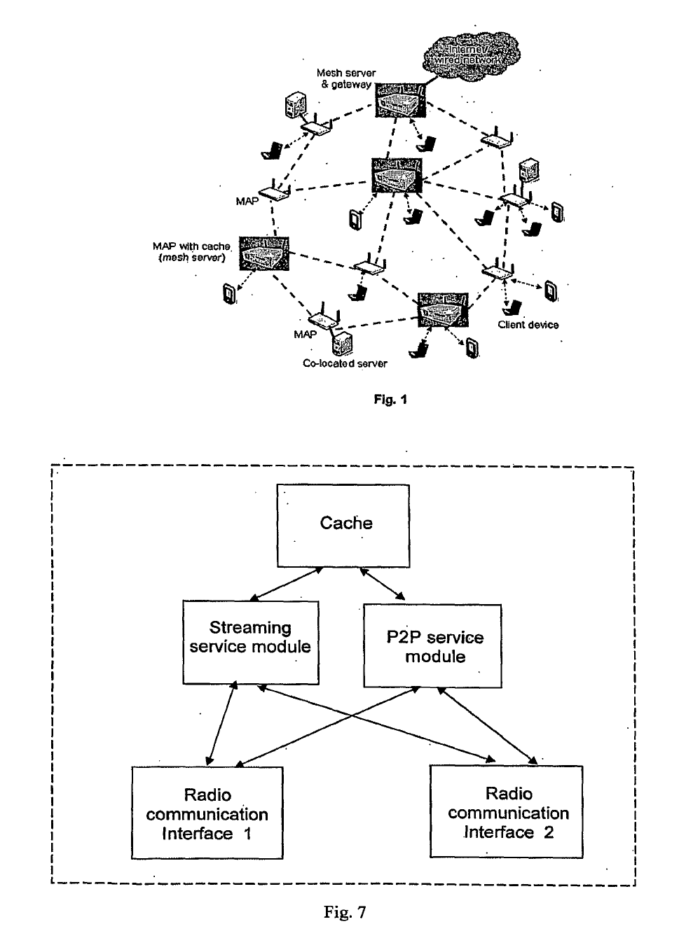

As used hereinafter, the terms MAP and mesh content server may be used interchangeably. However, as described above a mesh content is a MAP with cache or a MAP with a co-located content server. A gateway mesh content server is a gateway to a wired network such as the Internet with cache or a co-located content server. A gateway mesh content server is a mesh content server and also a gateway. FIG. 1 illustrates a content service system over WMNs. The content service system includes mesh access points (MAPs), mesh content servers and client devices. The MAPs and mesh content servers are interconnected via wireless links to form a wireless mesh multi-hop backhaul infrastructure. One or more MAPs connect to the wired network are referred to as gateways. MAPs and mesh content servers participate in routing and data forwarding.

Specifically, in FIG. 1, the Internet 105 is connected to and in communication with a gateway mesh content server 110. Gateway mesh content server 110 is connected to a MAP with a co-located content server 115a. MAPs with co-located content servers are also 115b and 115c. Gateway mesh content server 110 is also connected to and in communication with MAP with content cache 120a. MAP with content cache 120a and mesh content server 115a are both connected to and in communication with MAP 125a. MAPs are also 125b, 125c and 125d. Client devices/end devices 130 are connected to various MAPs and mesh content servers.

A MAP, supports two kinds of wireless functions, network access and data relay. The network access function provides network access for client devices/end devices. The relay function is used to construct the multi-hop wireless mesh backhaul and relay client devices' traffic to the destination. A mesh client device/client device (e.g., laptop, PDA and dual-mode smart phone etc.) associates with a nearby MAP to access the wireless mesh network. The client device does not participate in packet relay and routing. The client device sends (or receives) packets to (or from) its associated MAP. The rest of the packet delivery is handled by the MAP through a backhaul routing protocol.

In UPAC, it is assumed that there is a main content server which is the original content source. The main content server may reside outside the wireless mesh network or inside the wireless mesh network. It is further assumed that content is delivered to the mesh content servers of the present invention located within the wireless mesh network through mechanisms and means such as off-peak hours delivery. The mesh content servers have cache functionality or are co-located with content server.

The mesh content servers are placed according to the policy that each mesh client can access at least one mesh content server within a few hops. That is because each mesh content server will serve some parts of the content to the nearby client devices so that the hop count should be as small as possible. This is, especially true in a single radio wireless mesh network because the hop count affects the available bandwidth significantly. This is because a wireless mesh network is a shared medium, for example, an IEEE 802.11 network. In a shared medium a flow may interfere with itself during data forwarding from one hop to the next and also interfere with other neighboring flows. Thus, the performance in wireless mesh networks often degrades beyond two or three hops for applications requiring either high bandwidth or low latency.

In the UPAC, the content file is divided into multiple equal-size segments, denoted as clips. The playback time of the start of the clip minus a time delay D is defined as the deadline of this clip, i.e. the deadline for a clip is the time D before the playback time of the start of the clip. D is a parameter related to the network transmission and processing delay. For each clip, a client device may have different mesh content servers and peers. The client treats each clip as an independent file and obtains the clips in their original order before its deadline. By dividing the large file into clips, the client device can better adapt to dynamic network conditions and peer topologies. Different mesh content servers may cache different content or different clips of the same content. For each clip, a client device discovers the mesh content servers either in a centralized scheme via the main content server or in a distributed way. Then a primary mesh content server and a secondary mesh content server are selected.

In the UPAC of the present invention, there is also a tracker module (not shown). A P2P tracker module can be a MAP or a mesh content server or an entirely separate device. The P2P tracker module is a centralized source of the P2P network directory and provides directory information such as which devices have which content. A client device issues a request to the P2P tracker module if P2P fetching is activated. The P2P tracker module maintains the status of peers/users in the system. It should be noted that the mesh content servers can also run the P2P protocol and serve as a peer. The P2P tracker module sends feedback messages to the client device informing the client device of the set of the peers/users that can provide the same content as the client device is requesting. The client device then sets up peer relationships with the selected peers to fetch and provide data/content to itself and other peers.

Because of the limited content, network and processing resource, and dynamics each peer may have, there is no guarantee that the client device can get the data in time from other peers. The client device can request the first N content clips (N≧1) streamed from one or more mesh content servers to ensure that the content/data the client device wants is available and the startup delay is minimized. The client device requests the first clip (clip i=1) from its first clip's designated/selected primary mesh content server. If the primary mesh content server becomes unavailable, the client device will immediately request the first clip from its designated/selected secondary mesh content server. Then, the client device requests the second clip (clip i=2) from its second clip's primary (or secondary if the primary is unavailable or unable) mesh content server. This process continues until the clip i (i=N) is received from the clip i's primary (or secondary) mesh content server.

Meanwhile, the client device requests and fetches other clips of content (i>N) from its peers and tries to use peer resources as much as possible. For the P2P data fetching of each clip in UPAC, the clip is further divided into smaller chunks or sub-clips. These small chunks are exchanged (fetched or provided) among the peers. Within a clip, one example dissemination policy is that the rarest data chunks are first fetched from the peers. Other dissemination policies for the P2P data fetching can also be used.

If the content/data in a clip cannot be fetched from peers before the playback deadline, the client device requests the missing data from its primary mesh content server directly. Furthermore, if the primary mesh content server becomes unavailable, the client will immediately request the missing data from its secondary mesh content server. The primary or the secondary mesh content server streams the missing content/data to the client device in its original order.

In general, a mesh content server has three main tasks. First, a mesh content server is responsible for streaming the first N clips of the requested content, to the requesting client device. Second, a mesh content server provides complementary streaming for missing data before the playback deadline of a clip. Third, the mesh content server serves as a P2P seed for content/data. When a client device requests content, the client device takes some time to establish routes to peers and locate the desired content. In real time applications, a long startup delay is not desirable. In addition, there is no guarantee that other peers have the requested content/data, so the selected mesh content server transmits the first N clips of the content/data so that startup delay is reduced. Each clip of content should be fetched before its playback time. Once the playback deadline of a clip is reached, no P2P fetching of the playback clip is allowed since the newly downloaded data could be outdated. Complementary streaming from the mesh content server is initiated because complementary streaming provides content/data in its original order with less latency. Complementary streaming helps the client device get the data which cannot be fetched in time from other peers.

A P2P tracker module is used for P2P data fetching. The P2P tracker module for content/content clips is known in advance by the client devices. Each of the peers periodically updates their status with the P2P tracker module so that the P2P tracker module has the most recent/up-to-date information for the peers in the P2P network for the content/content clips. Once a client device requests content/data/clips, the client device will communicate with the P2P tracker module first and query the P2P tracker module regarding the peers from which the client device can obtain content which the client device needs/desires. Then the client device establishes (or tries to establish) a P2P relationship with the peers on a list provided by the P2P tracker module. Note that the client device only associates with one of the MAPs and does not participate in routing within the infrastructure WMN. The client device sends the peer request packet to the peer via the MAP with which the client device is associated. When the MAP receives a peer request packet (or any packet destined for another peer) from a client device with which it is associated, the MAP discovers, establishes, and maintains the best route to the peer on behalf of the client device based on the destination address in the peer request packet using an on-demand or proactive routing protocol and routing metrics.

To facilitate cross-layer design to improve P2P data fetching performance, the UPAC of the present invention implements a proxy at each MAP. The MAP informs the associated client device of the path cost to the client device's peers and whether the peer is associated with the same MAP as the requesting client device. Therefore, the client device has the path cost information to each of the peers with which the client device desires to establish communications for the purpose of exchanging content. When a client device fetches data from its associated peers, the client device gives higher priority to the peers associated with the same MAP or with better path cost.

Mesh content servers play an important role in increasing the network capacity and improving the QoS for content (audio, video and/or multimedia) services in infrastructure WMNs. In the present invention, there are several schemes for mesh content server discovery and selection as follows:
(1) Centralized scheme with server load as the selection metric (Centralized-Load Scheme). In this scheme, a client device sends a request to the main server. The main server selects a primary mesh content server and a secondary mesh content server to serve this client device. It informs the client device of the selected mesh content servers. The two mesh content servers with the least load or the least number of client devices being served are selected for the client device as the primary mesh content server and the secondary mesh content server, respectively. This mechanism does not require the client device to have information about the server load and the path quality to the server. However, it requires the mesh content servers to report their loads to the main server periodically.
(2) Overlay scheme with end-to-end delay as the selection metric (Overlay-Delay Scheme). In this scheme, the main server sends a list of candidate mesh content servers to the client device after the main server receives the request from the client device. The client device measures the end-to-end delay to each candidate mesh content server using probing packets. The client device selects the mesh content server with the minimum delay as the primary mesh content server, and the one with the second least end-to-end delay as the secondary mesh content server.
(3) Distributed scheme with hop count as the selection metric (Distributed-HopCount Scheme). In this scheme, the client device floods the wireless mesh network with a mesh content server request message for a content clip. Each mesh content server with the requested content clip sends a server reply to the requesting client device. Note that the client device is associated with a MAP and does not participate in routing. However, through the underlying routing protocol, the mesh content servers have hop count information from it to the MAP with which the requesting client device is associated. There may be multiple paths available between the mesh content server and the MAP with which the client device is associated. Only the path with the minimum hop count is selected and used by the routing mechanism. Each mesh content server uses its touting layer information and informs the client device of its minimum hop count to the client device's associated MAP in the server reply. The client device selects the mesh content server with the least value of the minimum hop count as the primary mesh content server and the one with the second least hop count as the secondary mesh content server.
(4) Distributed scheme with a routing metric as the selection metric (Distributed-Routing Metric Scheme). The wireless mesh network may run a routing protocol with a routing metric. For example, expected transmission time (ETT) is one such mesh routing metric. The ETT for a link L is defined as the expected MAC layer duration for successfully delivering a packet over the link. ETT_{L}=(1/1−e_{L})*s/r_{L}, where e_{L}, is the packet error rate, r_{L} is the transmission rate of link L, s is the packet size. The cost of a path p is simply the summation of the ETT's of all the links along the path. The ETT metric captures the impact of packet loss and link data rate on the performance of the path. The path with minimum path ETT cost is used by the routing protocol. In the Distributed-ETT mesh server selection scheme of the present invention, a cross-layer approach is employed for mesh server selection. Similar to the Distributed-HopCount scheme, the client device floods a mesh server request message over the wireless mesh network. Through the underlying routing protocol, the mesh content server obtains the path ETT cost of the best path from it to the MAP with which the client device is associated. The best path is the path with the minimum ETT path cost. Each mesh content server uses its routing layer information and informs the client device of the ETT cost of its best path to the MAP with which the client device is associated in the mesh server reply. The client device then selects the mesh content server with the least value of the path ETT cost as the primary mesh content server and the one with the second least path ETT cost as the secondary mesh content server.

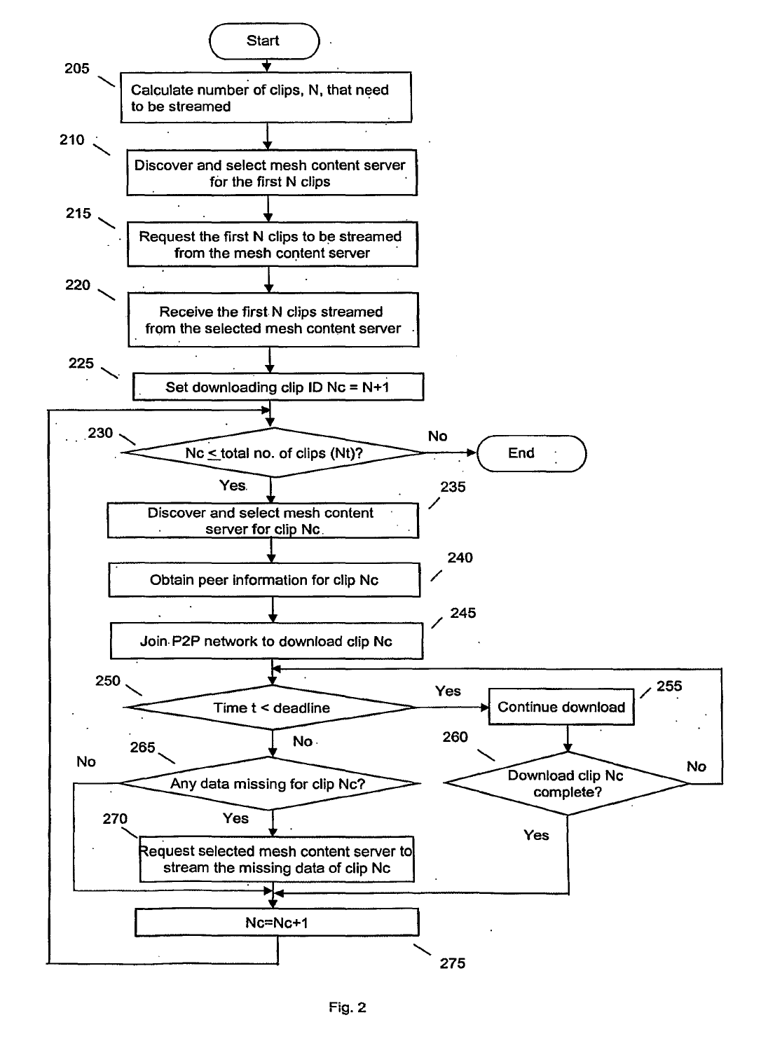

FIG. 2 is a flowchart of the unified peer-to-peer (P2P) and cache server (UPAC) content service process from the client device side. At 205; the client device estimates the number of clips, N, that need to be streamed. The client device then discovers and selects one or more mesh content servers from which to receive the first N clips at 210. At 215, the client device requests the first N clips from the selected mesh content server(s). The client device receives the requested N clips from the selected mesh content server(s) at 220. Each clip is treated as an independent file so this process may be repeated N times. A clip counter is initialed to one greater than N at 25. A test is performed at 230 to determine if all the clips for the content have been received. If all clips for the content have been received then the process ends. If all clips for the content have not been received then a mesh content server for the next clip is located and selected at 235. The client device tries to locate peer devices that have the next clip at 240. The client device joins the P2P network (if the client device is not already a member of the p2P network) in order to download the next clip at 245. A test is performed at 250 to determine if the time to receive the next clip has exceeded the deadline. If the deadline has not been exceeded then the content clip continues to be downloaded at 255. A test is then performed at 260 to determine if the clip download has been completed. If the clip download has not completed, then the process returns to 250. If the clip download has completed then the clip counter is incremented at 275. If the deadline for the clip download has been exceeded then a test is performed at 265 to determine if there is any data/content missing from the clip download. If there is missing data/content then the client device requests the missing data/content from a mesh content server at 270. If there is no missing data/content then the clip counter is incremented at 275. It should be noted that while the above exemplary embodiment uses an up-counter other counters such as a down-counter which would be decremented could be used.

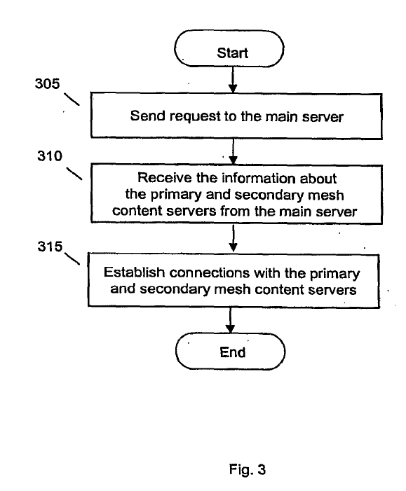

FIG. 3 is a flowchart of the centralized mesh content server selection method of the present invention. The centralized mesh content server selection scheme is one of several possible ways in which to discover mesh content server(s). The scheme used by the client device depends on the network topology, availability of the main server, availability of metric information etc. At 305 in the centralized scheme, the client device sends a request to the main server requesting the main server to assign/designate primary and secondary mesh content servers. The main server assign/designates primary and secondary mesh content servers based on the load of the available mesh content servers in the network Load may be the number of client devices that a mesh content server is servicing. The client device receives the assigned/designated mesh content servers from the main server at 310 and at 315 attempts to establish connection with the assigned/designated mesh content servers.

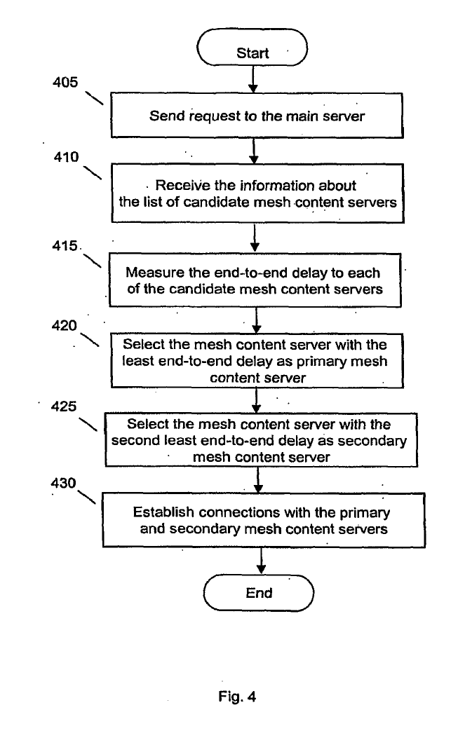

FIG. 4 is a flowchart of the overlay mesh content server selection method of the present invention using end-to-end delay as the selection criteria. The overlay mesh content server selection scheme is one of several possible ways in which to discover mesh content server(s). The scheme used by the client device depends on the network topology, availability of a main server, availability of metric information etc. At 405 in the overlay scheme, the client device sends a request to the main server requesting the main server to provide information regarding a list of candidate mesh content servers. The client device receives the requested information from the main server at 410. The client device then determines the end-to-end delay to each candidate mesh content server at 415. The client device then selects a primary mesh content server at 420 based on the least end-to-end delay. At 425 the client device selects a secondary mesh content server based on the next least end-to-end, delay. At 430, the client device attempts to establish connection with the selected mesh content servers.

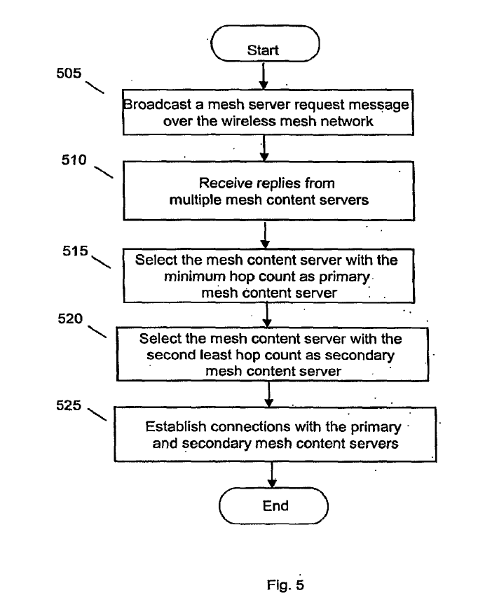

FIG. 5 is a flowchart of the distributed mesh content server selection method of the present invention using hop count as the selection criteria. The distributed mesh content server selection method of the present invention using hop count as the selection criteria is one of several possible ways in which to discover Mesh content server(s). The scheme used by the client device depends on the network topology, availability of a main server, availability of metric information etc. At 505, the client device broadcasts a mesh server request message over the wireless mesh network. The mesh server request message is used to gather information about the mesh content servers that are in the wireless mesh network including hop count, content availability etc. The client device receives response form the multiple mesh content servers in the wireless mesh network at 510. The client device then selects a primary mesh content server at 515 based on the mesh content server having a minimum hop count. At 520 the client device selects a secondary mesh content server based on the next least hop count. At 525, the client device attempts to establish connection with the selected mesh content servers.

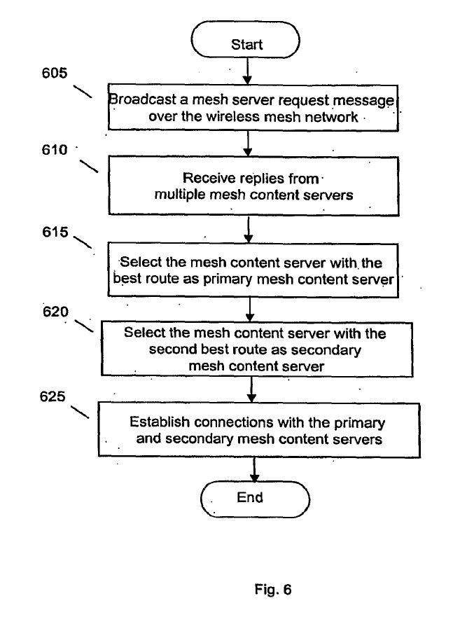

FIG. 6 is a flowchart of the distributed mesh content server selection method of the present invention using a routing metric as the selection criteria. The distributed mesh content server selection method of the present invention using a routing metric as the selection criteria is one of several possible ways in which to discover mesh content server(s). The scheme used by the client device depends on the network topology, availability of a main server, availability of metric information etc. At 605, the client device broadcasts a mesh server request message over the wireless mesh network. The mesh server request message is used to gather information about the mesh content servers that are in the wireless mesh network including routing metrics, content availability etc. The client device receives response from the multiple mesh content servers in the wireless mesh network at 610. The client device then selects a primary mesh content server at 615 based on the mesh content server having the best route. At 620 the client device selects a secondary mesh content server based on the next best route. At 625, the client device attempts to establish connection with the selected mesh content servers.

As described above, a client device treats each clip of content as a separate file to adapt to dynamic network conditions. The client device discovers and selects the primary and secondary mesh content servers for each clip independently. During the serving time of each content clip, if the primary mesh content server becomes unavailable, the client device will switch to the secondary mesh content server to obtain the content. Meanwhile the client device will re-initiate the server discovery and selection process using one of the above schemes to identify a new secondary mesh content server.

FIG. 7 is a block diagram of a mesh content server of the present invention. A mesh content server includes a cache, a streaming service module, a P2P service module, and one or more wireless communication interfaces. One wireless communication interface provides network access for client devices. Another wireless communication interface is used to participate in a wireless mesh backhaul network with other mesh content servers, MAPs or routers. The wireless mesh backhaul network provides for routing and data forwarding. Content is cached in the cache unit. The streaming service module receives the request from client devices and streams the content to the client devices. The P2P service module forms a P2P networked system with other mesh content servers and client devices.

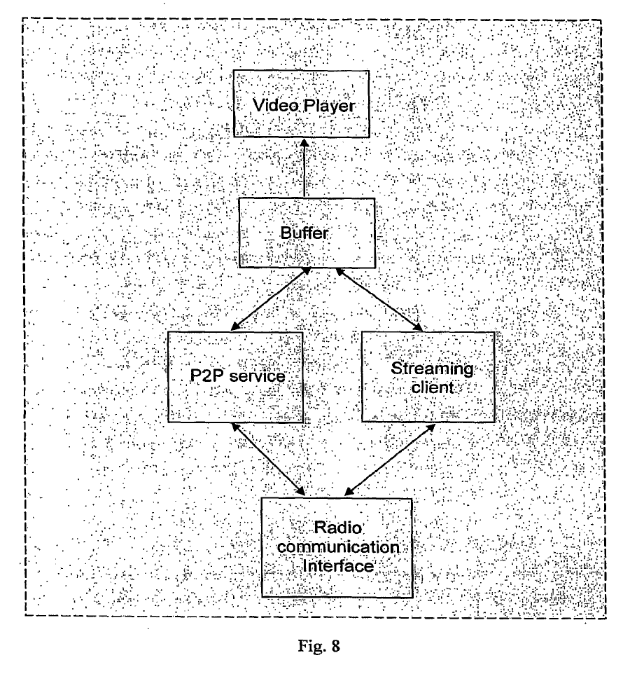

FIG. 8 is a client device of the present invention. A client device includes a P2P service module, a streaming client module, a buffer, a player, and one or more wireless (radio) interfaces. The client device associates with a MAP or mesh content server via its wireless interface. The P2P service module forms a P2P networked system with other client devices and mesh content server acting as peers in order to fetch/provide data. The streaming client module requests and receives streamed data from the mesh content server. The received data are stored in the buffer. The data in the buffer will be displayed by the player and may be fetched by other peers in the P2P system. Client devices (e.g., laptops, dual-mode smart phones, personal digital assistants (PDAs) etc.) associate with a nearby MAP to access the wireless mesh network. Client devices/end devices do not participate in packet relay or the routing process. A client device sends (or receives) packets to (or from) its associated MAP. Packet delivery is handled by the MAP through a backhaul routing protocol.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for receiving content over a wireless network, said method comprising:
determining a first server from which to receive a content clip to be streamed;
requesting said content clip to be streamed from said selected first server;
receiving said streamed content clip from said selected first server;
determining a peer device from which to receive a content clip to be downloaded;
requesting said content clip to be downloaded; and
receiving said downloaded content clip.

2. The method according to claim 1, wherein said first server a mesh content server.

3. The method according to claim 1, further comprising:
obtaining information for said peer device; and
joining a peer-to-peer network that includes said peer device.

4. The method according to claim 2, further comprising:
determining if said downloaded content clip was received prior to a deadline; and
requesting streaming of a missing part of said downloaded content clip that was not received prior to said deadline from said mesh content server.

5. The method according to claim 2, wherein said mesh content server is a mesh access point with content storage and processing capability.

6. The method according to claim 2, wherein said mesh content server is co-located with a mesh access point.

7. The method according to claim 2, further comprising calculating a number of content clips to be streamed.

8. The method according to claim 7, wherein said mesh content server for each content clip to be streamed is different.

9. The method according to claim 7, wherein said mesh content server for some content clips to be streamed is different.

10. The method according to claim 1, wherein received packets in said streamed content clip are received in order.

11. The method according to claim 1, wherein received packets in said downloaded content clip are received out of order.

12. The method according to claim 11, wherein said received packets in said downloaded out of order content clip content clip are buffered.

13. The method according to claim 2, wherein said determining said mesh content server further comprises:
sending a request message to a second server;
receiving information about a primary mesh content server and a secondary mesh content server from said second server; and
establishing connections with said primary mesh content server and said secondary mesh content server.

14. The method according to claim 13, wherein said second server is a main server.

15. The method according to claim 2, wherein said determining said mesh content server further comprises:
sending a request message to a second server;
receiving information about a list of candidate mesh content servers from said second server;
determining an end-to-end delay to each candidate mesh content server;
selecting a primary mesh content server based on a least end-to-end delay;
selecting a secondary mesh content server based on a next least end-to-end delay; and
establishing connections with said primary mesh content server and said secondary mesh content server.

16. The method according to claim 14, wherein said second server is a main server.

17. The method according to claim 2, wherein said determining said mesh content server further comprises:
broadcasting a mesh content server request message over said wireless network;
receiving responses from a plurality of mesh content servers;
selecting a primary mesh content server based on a lowest hop count between said requester and said responding mesh content servers;
selecting a secondary mesh, content server based on a next lowest hop count between said requester and said responding mesh content servers; and
establishing connections with said primary mesh content server and said secondary mesh content server.

18. The method according to claim 2, wherein said determining said mesh content server further comprises:
broadcasting a mesh content server request message over said wireless network;
receiving responses from a plurality of mesh content servers;
selecting a primary mesh content server based on a best route between said requester and said responding mesh content servers;
selecting a secondary mesh content server based on a next best route between said requester and said responding mesh content servers; and
establishing connections with said primary mesh content server and said secondary mesh content server.

19. A device for receiving content over a wireless network, comprising:
means for determining a first server from which to receive a content clip to be streamed;
means for requesting said content clip to be streamed from said selected first server;
means for receiving said streamed content clip from said selected first server;
means for determining a peer device from which to receive a content clip to be downloaded;
means for requesting said content clip to be downloaded; and
means for receiving said downloaded content clip.

20. The device according to claim 19, wherein said first server is a mesh content server.

21. The device according to claim 19, further comprising:
means for obtaining information for said peer device; and
means for joining a peer-to-peer network that includes said peer device.

22. The device according to claim 20, further comprising:
means for determining if said downloaded content clip was received prior to a deadline; and
means for requesting streaming of a missing part of said downloaded content clip that was not received prior to said deadline from said mesh content server.

23. The device according to claim 20, further comprising means for calculating a number of content clips to be streamed.

24. The device according to claim 20, wherein said mesh content server and said peer device are the same.

25. The device according to claim 20, wherein said mesh content server for each content clip to be streamed is different.

26. The device according to claim 20, wherein said mesh content server for some content clips to be streamed is different.

27. The device according to claim 19, wherein received packets in said streamed content clip are received in order.

28. The device according to claim 19, wherein received packets in said downloaded content clip are received out of order.

29. The device according to claim 28, wherein said received packets in said downloaded out of order content clip are buffered.

30. The device according to claim 20, wherein said means for determining said mesh content server further comprise:
means for sending a request message to a second server;
means for receiving information about a primary mesh content server and secondary mesh content server from said second server; and
means for establishing connections with said primary mesh content server and said secondary mesh content server.

31. The device according to claim 30, wherein said second server is a main server.

32. The device according to claim 20, wherein said means for determining said mesh content server further comprise:
means for sending a request message to a second server;
means for receiving information about a list of candidate mesh content servers from said second server;
means for determining an end-to-end delay to each candidate mesh content server;
means for selecting a primary mesh content server based on a least end-to-end delay;
means for selecting a secondary mesh content server based on a next least end-to-end delay; and
means for establishing connections with said primary mesh content server and said secondary mesh content server.

33. The device according t claim 32, wherein said second server is a main server.

34. The device according to claim 20, wherein said means for determining said mesh content server further comprises:
means for broadcasting a mesh content server request message over said wireless network;
means for receiving responses from a plurality of mesh content servers;
means for selecting a primary mesh content server based on a lowest hop count between said device and said responding mesh content servers;
means for selecting a secondary mesh content server based on a nest lowest hop count between said device and said responding mesh content servers; and
means for establishing connections with said primary mesh content server and said secondary mesh content server.

35. The device according to claim 20, wherein said means for determining said mesh content server further comprise:
means for broadcasting a mesh content server request message over said wireless network;
means for receiving responses from a plurality of mesh content servers;
means for selecting a primary mesh content server based on a best route between said device and said responding mesh content servers;
means for selecting a secondary mesh content server based on a nest best route between said device and said responding mesh content servers; and
means for establishing connections with said primary mesh content server and said secondary mesh content server.
